(19) United States
(12) Patent Application Publication
(10) Pub. No.: US 2014/0139533 A1
(43) Pub. Date: May 22, 2014

(54) GRAPHIC PROCESSING UNIT VIRTUAL APPARATUS, GRAPHIC PROCESSING UNIT HOST APPARATUS, AND GRAPHIC PROCESSING UNIT PROGRAM PROCESSING METHODS THEREOF

(71) Applicant: INSTITUTE FOR INFORMATION INDUSTRY, Taipei (TW)

(72) Inventors: Kai-Yuan JAN, Taipei City (TW); Chung-Ting KAO, Taipei City (TW); Feng-Sheng WANG, Tainan City (TW)

(73) Assignee: INSTITUTE FOR INFORMATION INDUSTRY, Taipei (TW)

(21) Appl. No.: 13/746,444

(22) Filed: Jan. 22, 2013

(30) Foreign Application Priority Data
Nov. 21, 2012 (TW) 101143503

(51) Int. Cl. G06F 15/76

(52) U.S. Cl. CPC G06F 15/76
USPC 345/520

(57) ABSTRACT

A graphic processing unit (GPU) virtual apparatus, a GPU host apparatus and GPU program processing methods thereof are provided. The GPU virtual apparatus determines a priority of a GPU program, determines a processing order of the GPU program according to the priority, processes the GPU program according to the processing order, and transmits the processed GPU program to the GPU host apparatus. The GPU host apparatus receives the processed GPU program from the GPU virtual apparatus, determines a priority of the processed GPU program, determines a processing order of the processed GPU program according to the priority, further processes the processed GPU program according to the processing order, and transmits an operation result of the processed GPU program to the GPU virtual apparatus.

### PRIORITY

This application claims priority to Taiwan Patent Application No. 101143503 filed on Nov. 21, 2012, which is hereby incorporated by reference in its entirety.

### FIELD

The present invention relates to a graphic processing unit (GPU) virtual apparatus, a GPU host apparatus, and GPU program processing methods thereof. More particularly, the present invention provides a GPU virtual apparatus, a GPU host apparatus, and GPU program processing methods thereof that are related to priority scheduling.

### BACKGROUND

The graphics processing unit (GPU) is a kind of microprocessor specially used for processing image operations. In a computer cluster, image operations in computers without a physical GPU (i.e., GPU virtual apparatuses) can still be processed with the aid of computers with physical GPUs (e.g., GPU host apparatuses) in the computer cluster via a remote interface program and the Internet. Thereby, resource allocations for image operations can be achieved. This is called “virtual GPU operations”. However, as being limited by the network bandwidth, it is often impossible to effectively achieve desirable performances of the virtual GPU operations in the computer cluster.

In order to make the virtual GPU operations in the computer cluster more efficient, it is general to improve the GPU program compiler. More specifically, improving the remote interface program of GPU virtual apparatuses to enable the compiler to re-compile the GPU program can simplify the program codes of the GPU program. In this way, the number of communications between the GPU virtual apparatuses and the GPU host apparatuses can be reduced so as to improve the graphic acceleration performance. However, this method can only reduce the number of communications between the GPU virtual apparatuses and the GPU host apparatuses, so it has only a very limited effect when a lot of pictures or image data need to be processed.

Another way is to record and analyze workloads of the GPU host apparatuses through monitoring, and when a GPU program needs to be executed, the resources are allocated according to the workloads of the GPU host apparatuses so that the workloads are uniformly distributed among all the GPU host apparatuses in the computer cluster. However, this requires use of an additional algorithm, so when it is desired to dynamically perform virtual GPU operations, an allocation strategy must be re-calculated, which will extend the time duration of the virtual GPU operations.

Accordingly, an urgent need exists in the art to provide a solution capable of improving the performance of virtual GPU operations in a computer cluster more effectively.

### SUMMARY

The primary objective of the present invention is to provide a graphic processing unit (GPU) virtual apparatus, a GPU host apparatus, and GPU program processing methods thereof that can improve the performance of virtual GPU operations in a computer cluster. When a GPU program is detected, the GPU virtual apparatus, the GPU host apparatus, and the GPU program processing methods thereof of the present invention determine a priority of the GPU program firstly, and then determine a processing order of the GPU program according to the priority to make the optimal scheduling. Therefore, the present invention can effectively save the time necessary for processing the GPU program in both the GPU virtual apparatus and the GPU host apparatus.

Because the present invention uses a priority determining mechanism to make the scheduling, the time necessary for processing the GPU program is reduced to improve the performance of virtual GPU operations in a computer cluster. Thereby, when a lot of pictures or image data need to be processed or when virtual GPU operations need to be dynamically performed, the present invention can still effectively save the time necessary for processing the GPU program. In a word, the present invention can effectively improve the performance of virtual GPU operations in the computer cluster.

To achieve the aforesaid objective, certain embodiments of the present invention provide a GPU virtual apparatus. The GPU virtual apparatus comprises a transmitting/receiving interface, a priority determining device, and a processor electrically connected to the transmitting/receiving interface and the priority determining device. The priority determining device is configured to determine a priority of a GPU program. The processor is configured to execute the following operations: determining a processing order of the GPU program according to the priority; processing the GPU program according to the processing order; transmitting a processed GPU program to a GPU host apparatus via the transmitting/receiving interface; and receiving an operation result of the processed GPU program from the GPU host apparatus via the transmitting/receiving interface.

To achieve the aforesaid objective, certain embodiments of the present invention provide a GPU host apparatus for use with the aforesaid GPU virtual apparatus. The GPU host apparatus comprises a transmitting/receiving interface, a priority determining device, and a processor electrically connected to the transmitting/receiving interface and the priority determining device. The transmitting/receiving interface is configured to receive the processed GPU program from the GPU virtual apparatus. The priority determining device is configured to determine a priority of the processed GPU program. The processor is configured to execute the following operations: determining a processing order of the processed GPU program according to the priority; processing the processed GPU program according to the processing order; and transmitting an operation result of the processed GPU program to the GPU virtual apparatus via the transmitting/receiving interface.

To achieve the aforesaid objective, certain embodiments of the present invention provide a GPU program front-end processing method for use in a GPU virtual apparatus. The GPU virtual apparatus comprises a transmitting/receiving interface, a priority determining device, and a processor electrically connected to the transmitting/receiving interface and the priority determining device. The GPU program front-end processing method comprises the following steps of:

(a) enabling the priority determining device to determine a priority of a GPU program;

(b) enabling the processor to determine a processing order of the GPU program according to the priority;

(c) enabling the processor to process the GPU program according to the processing order;

(d) enabling the processor to transmit a processed GPU program to a GPU host apparatus via the transmitting/receiving interface; and

(e) enabling the processor to receive an operation result of the processed GPU program from the GPU host apparatus via the transmitting/receiving interface.

To achieve the aforesaid objective, certain embodiments of the present invention provide a GPU program back-end processing method for use with the aforesaid GPU program front-end processing method. The GPU program back-end processing method is for use in a GPU host apparatus, and the GPU host apparatus comprises a transmitting/receiving interface, a priority determining device, and a processor electrically connected to the transmitting/receiving interface and the priority determining device. The GPU program back-end processing method comprises the following steps of:

(a) enabling the transmitting/receiving interface of the GPU host apparatus to receive the processed GPU program from the GPU virtual apparatus;

(b) enabling the priority determining device of the GPU host apparatus to determine a priority of the processed GPU program;

(c) enabling the processor of the GPU host apparatus to determine a processing order of the processed GPU program according to the priority;

(d) enabling the processor of the GPU host apparatus to process the processed GPU program according to the processing order; and

(e) enabling the processor of the GPU host apparatus to transmit an operation result of the processed GPU program to the GPU virtual apparatus via the transmitting/receiving interface.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic structural view of a GPU scheduling system 1 according to a first embodiment of the present invention;

FIG. 2A is a schematic view illustrating an order in which a GPU virtual apparatus 11 processes a GPU program 20 according to the first embodiment of the present invention;

FIG. 2B is a schematic view illustrating another order in which the GPU virtual apparatus 11 processes the GPU program 20 according to the first embodiment of the present invention;

FIG. 3A is a schematic view of a to-be-processed program set P according to the first embodiment of the present invention;

FIG. 3B is a schematic view illustrating a processing time taken to process the to-be-processed program set P by the Round Robin Algorithm according to the first embodiment of the present invention;

FIG. 3C is a schematic view illustrating a processing time taken to process the to-be-processed program set P by the First-Come First-Served Algorithm according to the first embodiment of the present invention;

FIG. 3D is a schematic view illustrating a processing time taken to process the to-be-processed program set P by the priority scheduling mechanism according to the first embodiment of the present invention; and

FIG. 4 is a flowchart diagram of a GPU program scheduling method according to a second embodiment of the present invention.

### DETAILED DESCRIPTION

The present invention can be explained with reference to the following example embodiments. However, these example embodiments are not intended to limit the present invention to any specific examples, embodiments, environments, applications or implementations described in these embodiments. Therefore, description of these embodiments is only for purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

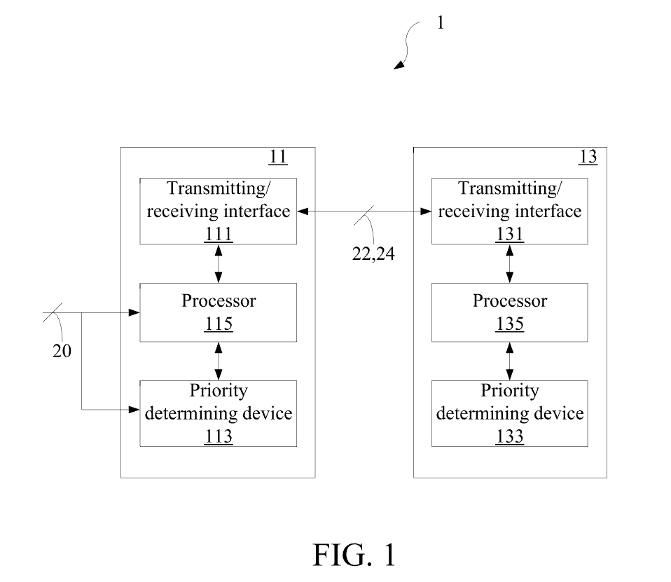

A first embodiment of the present invention is a graphic processing unit (GPU) program scheduling system. A schematic structural view of the GPU program scheduling system 1 is shown in FIG. 1. The GPU program scheduling system 1 comprises a GPU virtual apparatus 11 and a GPU host apparatus 13. The GPU program scheduling system 1 may be a computer cluster comprising a plurality of computers. The GPU virtual apparatus 11 is a computer without a physical GPU in the computer cluster, and the GPU host apparatus 13 is a computer with a physical GPU in the computer cluster. The GPU virtual apparatus 11 and the GPU host apparatus 13 may be connected with each other via the Internet to allow for communications and data transmissions therebetween.

The GPU virtual apparatus 11 may comprise a transmitting/receiving interface 111, a priority determining device 113, and a processor 115 electrically connected to the transmitting/receiving interface 111 and the priority determining device 113. The GPU virtual apparatus 11 may have different implementations, for example but not limited to, various electronic apparatuses that can form a computer cluster such as desktop computers, tablet computers, notebook computers and mobile phones; however, the GPU virtual apparatus 11 does not have a physical GPU.

The priority determining device 113 is configured to monitor in real time programs which are to be processed by the GPU virtual apparatus 11, and determine and analyze priorities of the programs. The programs may include a general central processing unit (CPU) program and a GPU program. The general CPU program can be processed by the GPU virtual apparatus 11 independently; however, the GPU program must be processed by both the GPU virtual apparatus 11 and the GPU host apparatus 13 jointly because the GPU virtual apparatus 11 does not have a physical GPU.

When a user of the GPU virtual apparatus 11 is to execute a GPU program 20, the priority determining device 113 analyzes the GPU program 20 firstly and determines a priority of the GPU program 20 accordingly. The priority determining device 113 may use various characteristics of the GPU program 20 as a basis for determining the priority of the GPU program 20. For example, the priority determining device 113 may determine the priority of the GPU program 20 according to the time necessary for the GPU virtual apparatus 11 to process the GPU program 20, the time necessary for the GPU host apparatus 13 to process the GPU program 20, a data traffic of the GPU program 20, an operating speed of the GPU virtual apparatus 11, an operating speed of the GPU host apparatus 13, the transmission bandwidth performance and so on.

Essentially, the more the related factors used as the basis are, the more accurately the priority determining device 113 will determine the priority of the GPU program 20 but the more the time taken will be. In practice, the user may make the optimal compromise between the determination accuracy and the processing time of the priority depending on different requirements, and may change the related factors appropriately according to different circumstances.

For convenience of description, the priority determining device 113 only uses a processing time, which is taken by the GPU host apparatus 13 to process the GPU program 20, as a basis for determining a priority of the GPU program 20. The longer the processing time is, the higher the priority will be. Through determination on the priority of the GPU program 20 by the priority determining device 113, the processor 115 determines a processing order of the GPU program 20 according to the priority of the GPU program 20 and processes the GPU program 20 according to the processing order.

The processor 115 may process the GPU program 20 in real time through a real-time operation system (RTOS). Specifically, if there is already a predetermined program to be processed by the processor 115 in the processing order of the GPU program 20, then the processor 115 will firstly stop processing the predetermined program to preferentially process the GPU program 20. This is called the preemptive scheduling. The processor 115 also temporarily stores statuses of a memory and a register of the predetermined program, and restores the statuses of the memory and the register of the predetermined program to resume processing of the predetermined program after having processed the GPU program 20. The predetermined program described in this embodiment may be a general CPU program or a GPU program.

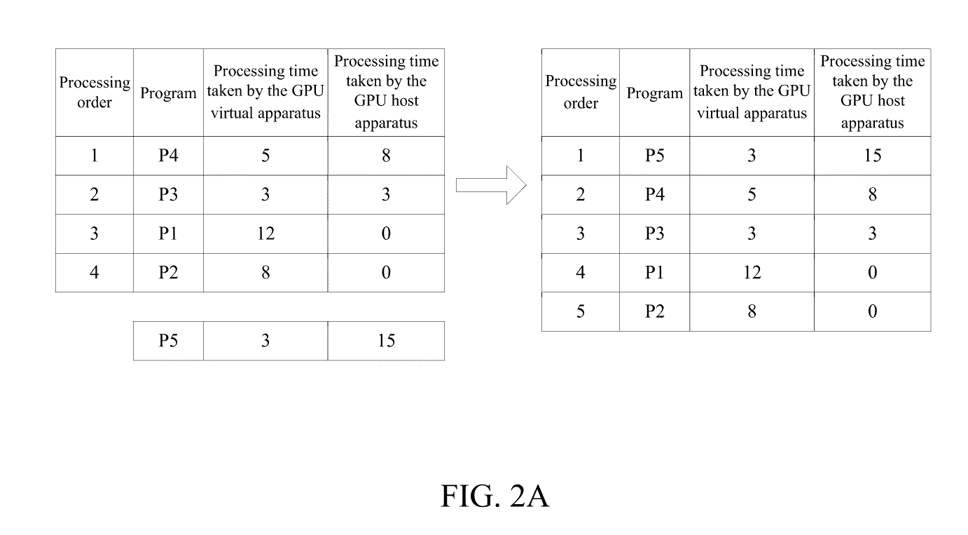

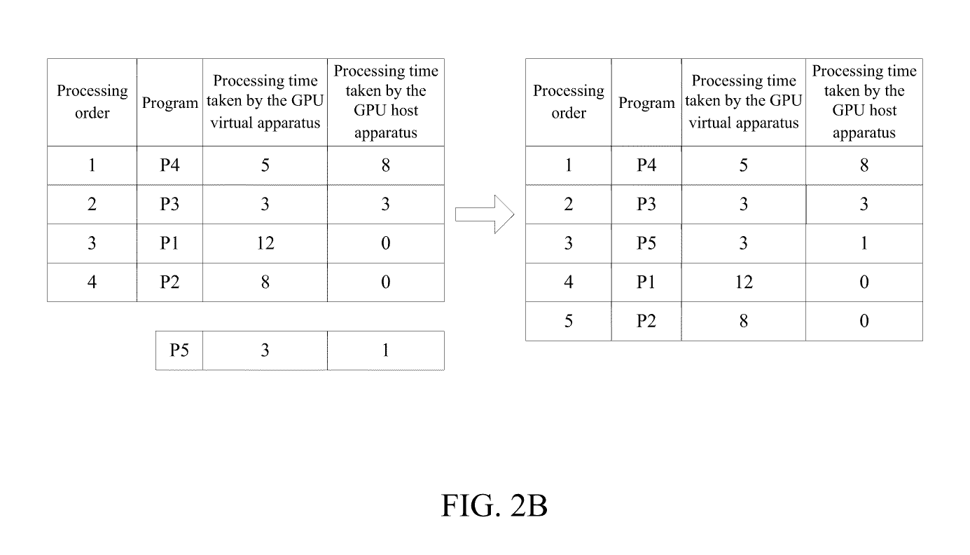

Hereinafter, how the GPU virtual apparatus 11 processes the GPU program 20 according to the processing order of the GPU program 20 will be further described by taking FIG. 2A and FIG. 2B as examples. FIG. 2A and FIG. 2B are schematic views illustrating two processing orders in which the GPU virtual apparatus 11 processes the GPU program 20 respectively.

As shown in FIG. 2A, suppose that there are four programs (i.e., a program P1, a program P2, a program P3 and a program P4) that must be processed, with the program P1 and the program P2 being CPU programs that need to be processed by only the GPU virtual apparatus 11 independently and the program P3 and the program P4 being GPU programs that need to be processed by both the GPU virtual apparatus 11 and the GPU host apparatus 13.

In this example, suppose that the priority determining device 113 determines a priority of each of the program P1, the program P2, the program P3 and the program P4 according to a processing time taken by the GPU host apparatus 13 to process each of the program P1, the program P2, the program P3 and the program P4. Therefore, the priority determining device 113 can obtain a priority of each of the program P1, the program P2, the program P3 and the program P4 after analyzing the program P1, the program P2, the program P3 and the program P4.

According to the priorities, the processor 115 schedules the program P1, the program P2, the program P3 and the program P4 to establish a processing sequence as shown in FIG. 2A; that is, the processor 115 will process the program P4, the program P3, the program P1 and the program P2 in sequence. Because the program P1 and the program P2 are CPU programs that need to be processed by only the GPU virtual apparatus 11 independently, they will be scheduled according to only the processing times taken by the GPU virtual apparatus 11. Therefore, the program P1 will be processed preferentially (the processing time thereof is longer), and the program P2 will be processed later (the processing time thereof is shorter). It shall be appreciated that, the processing orders of the CPU programs such as the program P1 and the program P2 are illustrated only for convenience of description but are not intended to limit implementations of the present invention.

If the priority determining device 113 detects that the user is to execute the GPU program 20 (i.e., a program P5 in FIG. 2A) while the program P4 is being processed by the processor 115, then the priority determining device 113 will determine a priority of the program P5 according to a processing time taken by the GPU host apparatus 13 to process the program P5. The processing time taken by the GPU host apparatus 13 to process the program P5 is longer than those of the program P1, the program P2, the program P3 and the program P4, so the processor 115 determines that the program P5 ranks the first in the processing order. Then, the processor 115 stops processing the current program (i.e., the program P4) so as to preferentially process the program P5, and resumes processing of the program P4 after having processed the program P5. In other words, the processor 115 will process the program P5, the program P4, the program P3, the program P1 and the program P2 in sequence.

Similarly, FIG. 2B depicts a case of another processing sequence. If the priority determining device 113 detects that the user is to execute the GPU program 20 (i.e., a program P5 in FIG. 2B) while the program P4 is being processed by the processor 115, then the priority determining device 113 will determine a priority of the program P5 according to a processing time taken by the GPU host apparatus 13 to process the program P5. The processing time taken by the GPU host apparatus 13 to process the program P5 is between those of the program P3 and the program P1, so the processor 115 determines that the program P5 ranks the third in the processing order. Then, after executing the program P4 and the program P3 in sequence, the processor 115 stops processing a predetermined program (i.e., the program P1), which was originally predetermined to rank the third in the processing order, so as to preferentially process the program P5. Then, the processor 115 resumes processing of the program P1 after having processed the program P5. In other words, the processor 115 will process the program P4, the program P3, the program P5, the program P1 and the program P2 in sequence.

After processing the GPU program 20, the processor 115 can transmit the processed GPU program 22 to the GPU host apparatus 13 having a physical GPU via the transmitting/receiving interface 111 for further processing. Communications and data transmissions between the transmitting/receiving interface 111 and the GPU host apparatus 13 may be carried out according to, for example but not limited to, the transmission control protocol/Internet protocol (TCP/IP) and via the Internet. Finally, after the processed GPU program 22 transmitted from the GPU virtual apparatus 11 is processed by the GPU host apparatus 13, the processor 115 can receive an operation result of the processed GPU program 22 from the GPU host apparatus 13 via the transmitting/receiving interface 111. Thereby, a virtual GPU operation is accomplished.

Hereinafter, the operations of the GPU host apparatus 13 will be further described. Similar to the GPU virtual apparatus 11, the GPU host apparatus 13 may comprise a transmitting/receiving interface 131, a priority determining device 133, and a processor 135 electrically connected to the transmitting/receiving interface 131 and the priority determining device 133. The GPU host apparatus 13 may also be implemented into different forms, for example but not limited to, in the form of various electronic apparatuses that can form a computer cluster such as desktop computers, tablet computers, notebook computers and mobile phones; however, the GPU host apparatus 13 has a physical GPU.

As described above, the processor 115 of the GPU virtual apparatus 11 can transmit the processed GPU program 22 to the GPU host apparatus 13 having a physical GPU via the transmitting/receiving interface 111 for further processing. Therefore, the transmitting/receiving interface 131 is used to receive the processed GPU program 22 from the GPU virtual apparatus 11. Communications and data transmissions between the transmitting/receiving interface 131 and the GPU host apparatus 13 may also be carried out according to, for example but not limited to, the TCP/IP and via the Internet.

After the processed GPU program 22 is received by the transmitting/receiving interface 131, the priority determining device 133 analyzes the processed GPU program 22, and determines a priority of the processed GPU program 22 according to a processing time taken by the GPU host apparatus 13 to process the processed GPU program 22. It shall be appreciated that, similar to the priority determining device 113, the priority determining device 133 may also use other characteristics of the processed GPU program 22 as a basis for determining the priority of the processed GPU program 22, but is not limited to the aforesaid determination basis.

Through determination on the priority of the processed GPU program 22 by the priority determining device 133, the processor 135 determines a processing order of the processed GPU program 22 according to the priority of the processed GPU program 22 and further processes the processed GPU program 22 according to the processing order.

Likewise, similar to the processor 115, the processor 135 may also process the processed GPU program 22 in real time through an RTOS. Specifically, if there is already a predetermined program to be processed by the processor 135 in the processing order of the processed GPU program 22, then the processor 135 will firstly stop processing the predetermined program to preferentially process the processed GPU program 22. The processor 135 also temporarily stores statuses of a memory and a register of the predetermined program, and restores the statuses of the memory and the register of the predetermined program to resume processing of the predetermined program after having processed the processed GPU program 22. The predetermined program described in this embodiment may be a general CPU program or a GPU program.

How the GPU host apparatus 13 processes the processed GPU program 22 according to the processing order of the processed GPU program 22 can be readily appreciated by those of ordinary skill in the art based on the aforesaid description about how the GPU virtual apparatus 11 processes the GPU program 20 according to the processing order of the GPU program 20, so it will not be further described herein.

After further processing the processed GPU program 22, the processor 135 transmits an operation result of the processed GPU program 22 to the transmitting/receiving interface 111 of the GPU virtual apparatus 11 via the transmitting/receiving interface 131. Thereby, a virtual GPU operation is accomplished. In other words, the GPU virtual apparatus 11 without a physical GPU can accomplish the operation of the GPU program 20 with the aid of the GPU host apparatus 13 with a physical GPU.

Making the scheduling through the priority mechanism can effectively reduce the overall operation time of the GPU program scheduling system 1. Hereinafter, comparison between the present invention and two common scheduling algorithms (including the Round Robin Algorithm and the First-Come First-Served Algorithm) will be further described with reference to an exemplary example.

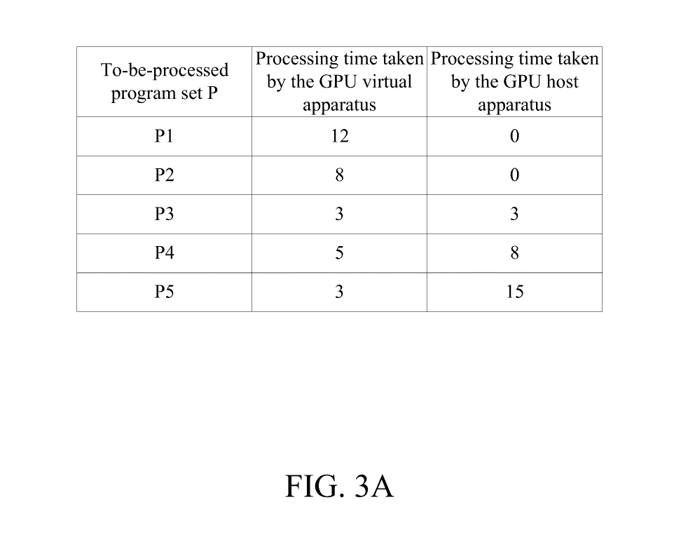

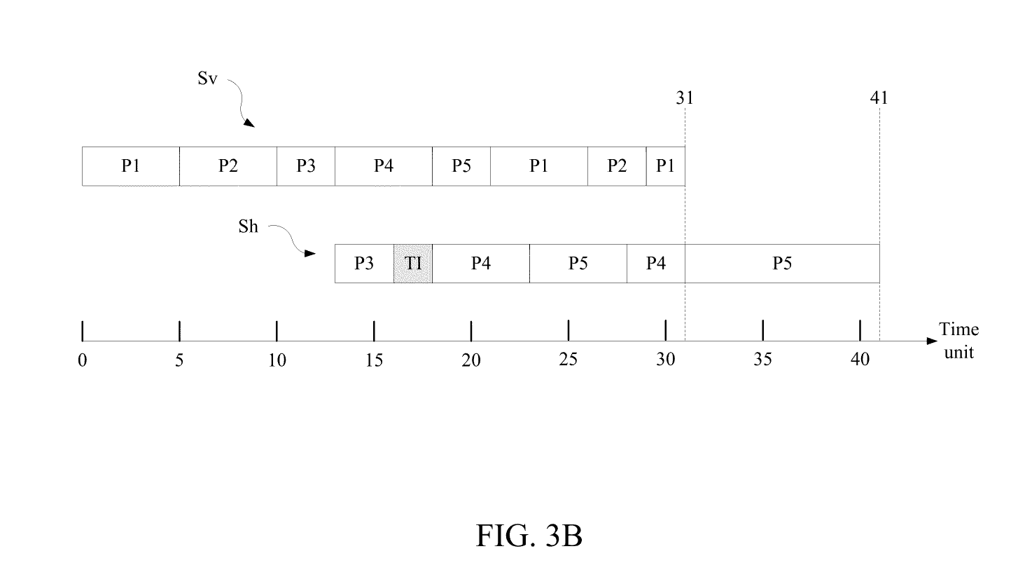

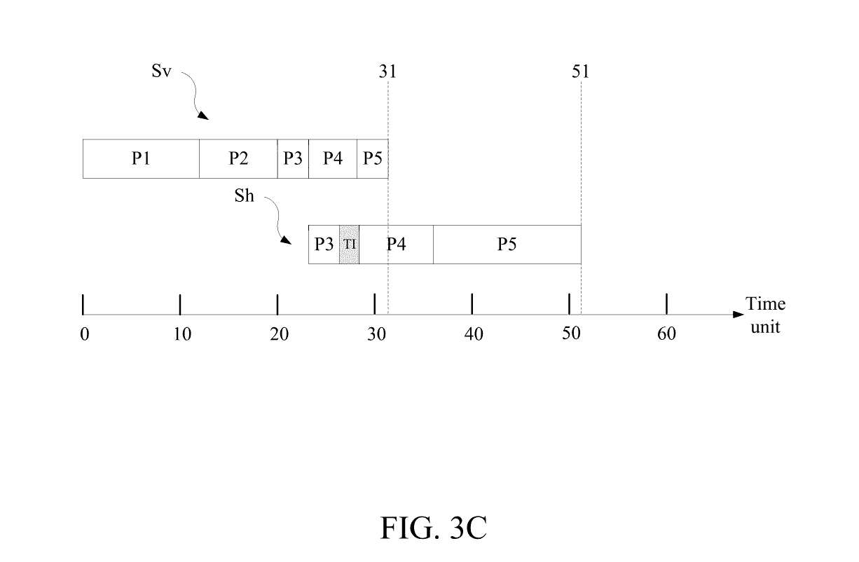

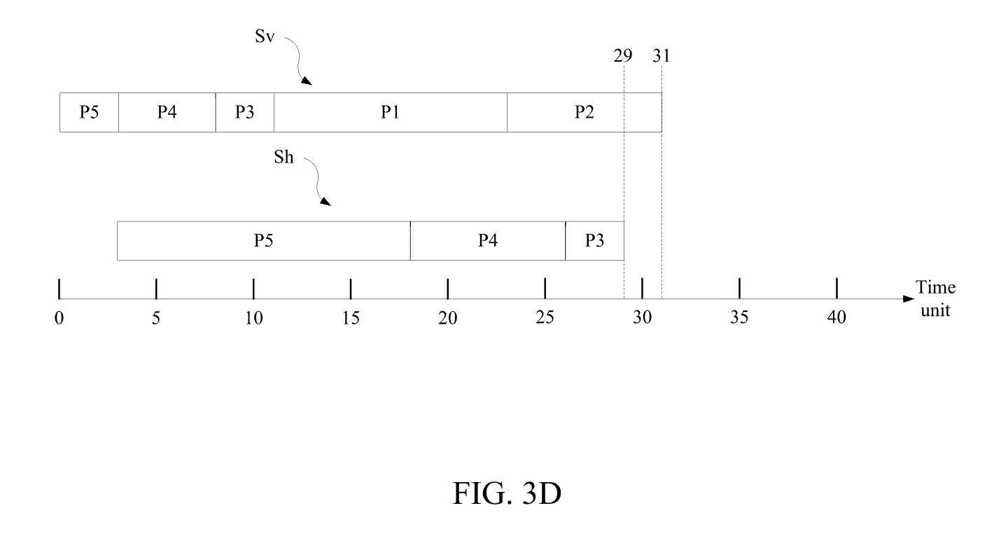

FIG. 3A is a schematic view of a to-be-processed program set P. The to-be-processed program set P comprises five programs that need to be processed, i.e., a program P1, a program P2, a program P3, a program P4 and a program P5. The program P1 and the program P2 are CPU programs that need to be processed by only the GPU virtual apparatus 11 independently, and the program P3, the program P4 and the program P5 are GPU programs that need to be processed by both the GPU virtual apparatus 11 and the GPU host apparatus 13. For convenience of description, it is supposed that there are no other programs needing to be processed when the program P3, the program P4 and the program P5 are processed by the GPU host apparatus 13.

FIG. 3B is a schematic view illustrating a processing time taken to process the to-be-processed program set P through use of the Round Robin Algorithm. It is supposed that a time quota for each processing operation is 5 time units. As shown in FIG. 3B, the GPU virtual apparatus 11 processes the program P1, the program P2, the program P3, the program P4 and the program P5 in sequence according to scheduling in a scheduling table Sv, with the processing time of each of the programs being 5 time units; and the GPU host apparatus 13 processes the program P3, the program P4 and the program P5 in sequence according to scheduling in a scheduling table Sh, with the processing time of each of the programs being 5 time units.

Thus, the processing time necessary for the GPU virtual apparatus 11 to process the program P1, the program P2, the program P3, the program P4 and the program P5 is 31 time units, and the processing time necessary for the GPU host apparatus 13 to process the program P3, the program P4 and the program P5 is 41 time units. The program P3, the program P4 and the program P5 cannot be processed by the GPU host apparatus 13 until they have been processed by the GPU virtual apparatus 11, so there is an idle time T1 of 2 time units between processing of the program P3 and processing of the program P4 by the GPU host apparatus 13.

FIG. 3C is a schematic view illustrating a processing time taken to process the to-be-processed program set P through use of the First-Come First-Served Algorithm. As shown in FIG. 3C, the GPU virtual apparatus 11 processes the program P1, the program P2, the program P3, the program P4 and the program P5 in sequence according to scheduling in a scheduling table Sv, and each of the programs will not be processed until the processing operation of the previous one of the programs has been completed; and the GPU host apparatus 13 processes the program P3, the program P4 and the program P5 in sequence according to scheduling in a scheduling table Sh, and each of the programs will not be processed until the processing operation of the previous one of the programs has been completed.

Thus, the processing time necessary for the GPU virtual apparatus 11 to process the program P1, the program P2, the program P3, the program P4 and the program P5 is 31 time units, and the processing time necessary for the GPU host apparatus 13 to process the program P3, the program P4 and the program P5 is 51 time units. The program P3, the program P4 and the program P5 cannot be processed by the GPU host apparatus 13 until they have been processed by the GPU virtual apparatus 11, so there is an idle time T1 of 2 time units between processing of the program P3 and processing of the program P4 by the GPU host apparatus 13.

FIG. 3D is a schematic view illustrating a processing time taken to process the to-be-processed program set P through use of the priority scheduling mechanism of this embodiment. By analyzing the programs to be processed, the priority determining device 113 and the priority determining device 133 can determine the priority of each of the programs comprised in the to-be-processed program set P and, accordingly, determine the optimal processing sequence to reduce the overall operation time of the GPU program scheduling system 1.

For each of the programs comprised in the to-be-processed program set P, the longer the time taken by the GPU host apparatus 13 to process the program is, the higher the priority of the program determined by the GPU program scheduling system 1 will be. Therefore, the processing sequence of the programs comprised in the to-be-processed program set P is: the program P5, the program P4, the program P3, the program P1 and the program P2. As described above, because the program P1 and the program P2 are CPU programs that need to be processed by only the GPU virtual apparatus 11 independently, they will be scheduled according to only the processing times taken by the GPU virtual apparatus 11. Therefore, the program P1 will be processed preferentially (the processing time thereof is longer), and the program P2 will be processed later (the processing time thereof is shorter).

Thus, as shown in FIG. 3D, the processing time necessary for the GPU virtual apparatus 11 to process the program P1, the program P2, the program P3, the program P4 and the program P5 is 31 time units, and the processing time necessary for the GPU host apparatus 13 to process the program P3, the program P4 and the program P5 is 29 time units.

As compared to the Round Robin Algorithm and the First-Come First-Served Algorithm, use of the priority scheduling mechanism of this embodiment can achieve the following benefit. Although the processing time necessary for the GPU virtual apparatus 11 is also 31 time units, the processing time necessary for the GPU host apparatus 13 is 29 time units. In other words, the time necessary for processing the to-be-processed program set P through use of the priority scheduling mechanism of this embodiment is only 31 time units; however, the times necessary for processing the to-be-processed program set P through use of the Round Robin Algorithm and through use of the First-Come First-Served Algorithm are 41 time units and 51 time units. Accordingly, making the scheduling through the priority mechanism can effectively reduce the overall operation time of the GPU program scheduling system 1.

A second embodiment of the present invention is a GPU program scheduling method. The GPU program processing method of this embodiment can be used in the GPU scheduling system 1 of the first embodiment. Therefore, the GPU virtual apparatus and the GPU host apparatus to be described later in this embodiment can be viewed as the GPU virtual apparatus 11 and the p GPU host apparatus 13 of the first embodiment.

The GPU virtual apparatus subsequently described in this embodiment may comprise a transmitting/receiving interface, a priority determining device, and a processor electrically connected to the transmitting/receiving interface and the priority determining device. The GPU host apparatus subsequently described in this embodiment may comprise a transmitting/receiving interface, a priority determining device, and a processor electrically connected to the transmitting/receiving interface and the priority determining device.

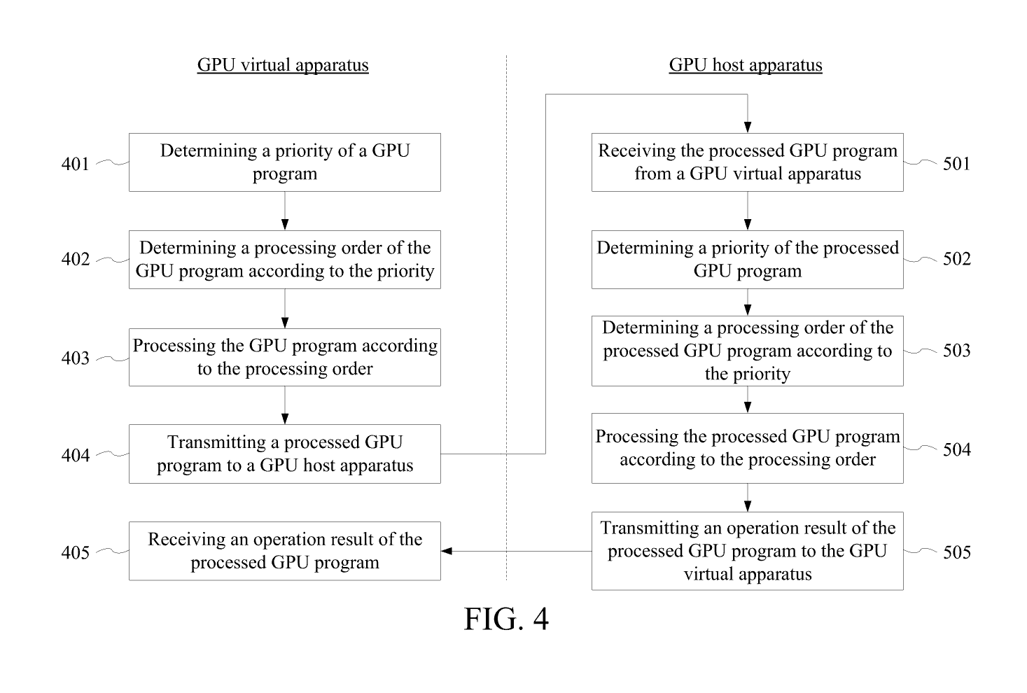

As shown in FIG. 4, the GPU program scheduling method of this embodiment may comprise a GPU program front-end processing method and a GPU program back-end processing method. The GPU program front-end processing method is for use in the GPU virtual apparatus, and the GPU program back-end processing method is for use in the GPU host apparatus. The GPU program front-end processing method comprises a step S401, a step S402, a step S403, a step S404 and a step S405; and the GPU program back-end processing method comprises a step S501, a step S502, a step S503, a step S504 and a step S505.

Firstly, in the GPU virtual apparatus, step S401 is executed to enable the priority determining device to determine a priority of a GPU program. Preferably, the priority determining device determines the priority of the GPU program according to a processing time taken by the GPU host apparatus to process the GPU program.

Step S402 is executed to enable the processor to determine a processing order of the GPU program according to the priority. Optionally, step S403 is executed to further enable the processor to stop processing a predetermined program so as to preferentially process the GPU program according to the processing order, and enable the processor to resume processing of the predetermined program after having processed the GPU program.

Step S403 is executed to enable the processor to process the GPU program according to the processing order. Step S404 is executed to enable the processor to transmit the processed GPU program to the GPU host apparatus via the transmitting/receiving interface.

Then, in the GPU host apparatus, step S501 is executed to enable the transmitting/receiving interface to receive the processed GPU program from the GPU virtual apparatus. Step S502 is executed to enable the priority determining device to determine a priority of the processed GPU program. Preferably, the priority determining device determines the priority of the GPU program according to a processing time taken by the GPU host apparatus to process the GPU program.

Step S503 is executed to enable the processor to determine a processing order of the processed GPU program according to the priority. Optionally, step S503 is executed to further enable the processor to stop processing a predetermined program so as to preferentially process the GPU program according to the processing order, and enable the processor to resume processing of the predetermined program after having processed the GPU program.

Step S504 is executed to enable the processor to further process the processed GPU program according to the processing order. Step S505 is executed to enable the processor to transmit an operation result of the processed GPU program to the GPU virtual apparatus via the transmitting/receiving interface.

Finally, in the GPU virtual apparatus, step S405 is executed to enable the processor to receive the operation result of the processed GPU program from the GPU host apparatus via the transmitting/receiving interface.

In addition to the aforesaid steps, the GPU program scheduling method of this embodiment can also execute all the operations of the GPU scheduling system 1 set forth in the first embodiment and accomplish all the corresponding functions. How the GPU program scheduling method of this embodiment executes these operations and accomplishes these functions can be readily appreciated by those of ordinary skill in the art based on the explanation of the first embodiment, and thus will not be further described herein.

According to the above descriptions, the present invention provides a GPU virtual apparatus, a GPU host apparatus, and GPU program processing methods thereof. When a GPU program is detected, the GPU virtual apparatus, the GPU host apparatus, and the GPU program processing methods thereof of the present invention determine a priority of the GPU program firstly, and then determine a processing order of the GPU program according to the priority to make the optimal scheduling. Therefore, the present invention can effectively save the time necessary for processing the GPU program in both the GPU virtual apparatus and the GPU host apparatus.

The present invention uses a priority determining mechanism to make the scheduling, and this can reduce the time necessary for processing the GPU program to improve the performance of virtual GPU operations in a computer cluster. Thereby, when a lot of pictures or image data need to be processed or when virtual GPU operations need to be dynamically performed, the present invention can still effectively save the time necessary for processing the GPU program. In a word, the present invention can effectively improve the performance of virtual GPU operations in the computer cluster.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A graphic processing unit (GPU) virtual apparatus, comprising:
a transmitting/receiving interface;
a priority determining device, being configured to determine a priority of a GPU program; and
a processor electrically connected to the transmitting/receiving interface and the priority determining device, being configured to execute the following operations:
determining a processing order of the GPU program according to the priority;
processing the GPU program according to the processing order;
transmitting a processed GPU program to a GPU host apparatus via the transmitting/receiving interface; and
receiving an operation result of the processed GPU program from the GPU host apparatus via the transmitting/receiving interface.

2. The GPU virtual apparatus as claimed in claim 1, wherein the processor stops processing a predetermined program so as to preferentially process the GPU program according to the processing order.

3. The GPU virtual apparatus as claimed in claim 2, wherein the processor further resumes processing of the predetermined program after having processed the GPU program.

4. The GPU virtual apparatus as claimed in claim 1, wherein the priority determining device determines the priority of the GPU program according to a processing time taken by the GPU host apparatus to process the GPU program.

5. A GPU host apparatus for use with the GPU virtual apparatus as claimed in claim 1, comprising:
a transmitting/receiving interface, being configured to receive the processed GPU program from the GPU virtual apparatus;
a priority determining device, being configured to determine a priority of the processed GPU program; and
a processor electrically connected to the transmitting/receiving interface and the priority determining device, being configured to execute the following operations:
determining a processing order of the processed GPU program according to the priority;
processing the processed GPU program according to the processing order; and
transmitting an operation result of the processed GPU program to the GPU virtual apparatus via the transmitting/receiving interface.

6. The GPU host apparatus as claimed in claim 5, wherein the processor further stops processing a predetermined program so as to preferentially process the processed GPU program according to the processing order.

7. The GPU host apparatus as claimed in claim 6, wherein the processor further resumes processing of the predetermined program after having processed the processed GPU program.

8. The GPU host apparatus as claimed in claim 5, wherein the priority determining device determines the priority of the processed GPU program according to a processing time taken by the GPU host apparatus to process the processed GPU program.

9. A GPU program front-end processing method for use in a GPU virtual apparatus, the GPU virtual apparatus comprising a transmitting/receiving interface, a priority determining device, and a processor electrically connected to the transmitting/receiving interface and the priority determining device, the GPU program front-end processing method comprising the steps of:
(a) enabling the priority determining device to determine a priority of a GPU program;
(b) enabling the processor to determine a processing order of the GPU program according to the priority;
(c) enabling the processor to process the GPU program according to the processing order;
(d) enabling the processor to transmit a processed GPU program to a GPU host apparatus via the transmitting/receiving interface; and
(e) enabling the processor to receive an operation result of the processed GPU program from the GPU host apparatus via the transmitting/receiving interface.

10. The GPU program front-end processing method as claimed in claim 9, wherein the step (c) further comprises the step of:
(c1) enabling the processor to stop processing a predetermined program so as to preferentially process the GPU program according to the processing order.

11. The GPU program front-end processing method as claimed in claim 10, wherein the step (c) further comprises the step of:
(c2) enabling the processor to resume processing of the predetermined program after having processed the GPU program.

12. The GPU program front-end processing method as claimed in claim 9, wherein the priority determining device determines the priority of the GPU program according to a processing time taken by the GPU host apparatus to process the GPU program.

13. A GPU program back-end processing method for use with the GPU program front-end processing method as claimed in claim 9, the GPU program back-end processing method being for use in a GPU host apparatus, the GPU host apparatus comprising a transmitting/receiving interface, a priority determining device, and a processor electrically connected to the transmitting/receiving interface and the priority determining device, the GPU program back-end processing method comprising the steps of:
(a) enabling the transmitting/receiving interface of the GPU host apparatus to receive the processed GPU program from the GPU virtual apparatus;
(b) enabling the priority determining device of the GPU host apparatus to determine a priority of the processed GPU program;
(c) enabling the processor of the GPU host apparatus to determine a processing order of the processed GPU program according to the priority;
(d) enabling the processor of the GPU host apparatus to process the processed GPU program according to the processing order; and
(e) enabling the processor of the GPU host apparatus to transmit an operation result of the processed GPU program to the GPU virtual apparatus via the transmitting/receiving interface.

14. The GPU program back-end processing method as claimed in claim 13, wherein the step (d) further comprises the step of:
(d1) enabling the processor of the GPU host apparatus to stop processing a predetermined program so as to preferentially process the processed GPU program according to the processing order.

15. The GPU program back-end processing method as claimed in claim 14, wherein the step (d) further comprises the step of:
(d2) enabling the processor of the GPU host apparatus to resume processing of the predetermined program after having processed the processed GPU program.

16. The GPU program back-end processing method as claimed in claim 13, wherein the priority determining device of the GPU host apparatus determines the priority of the processed GPU program according to a processing time taken by the GPU host apparatus to process the processed GPU program.
